(19) United States
(12) Patent Application Publication
(10) Pub. No.: US 2023/0381799 A1
(43) Pub. Date: Nov. 30, 2023

(54) SPRAY NOZZLE DEVICE

(71) Applicant: Bigger Ltd, London (GB)

(72) Inventor: Stuart SEMPLE, London (GB)

(73) Assignee: Bigger Ltd, London (GB)

(21) Appl. No.: 18/247,983

(22) PCT Filed: Oct. 4, 2021
(86) PCT No.: PCT/GB2021/052556

§ 371 Date: Apr. 5, 2023

(30) Foreign Application Priority Data
Oct. 5, 2020 (GB) 2015763.2

(51) Int. Cl. B05B 9/08; B05B 7/24

(52) U.S. Cl. CPC B05B 9/0805; B05B 7/2416

(57) ABSTRACT

A spray nozzle device (100) comprises a connector (120), an inlet valve (130), and a spray nozzle (140). The connector (12) allows the device to be connected to a container (200) containing a fluid (201). The inlet valve (130) can be removably attached to a pump or a source of pressurised gas (300) to allow the interior of a said container (200) to be pressurised. The spray nozzle (140) is constructed and arranged so that, when the device (100)is connected to a container (200), the interior of which has been pressurised via the inlet valve (130), operation of the spray nozzle (140) causes fluid to be sprayed from the container (200) via the

### BACKGROUND

Devices for spraying liquids can be used for a variety of purposes, e.g. artists may use aerosol spray paint cans to spray paint to create works of art, gardeners may use a garden sprayer to apply pesticide to plants, etc.

These types of devices generally comprise a nozzle and a bottle for storing the liquid under pressure. A typical nozzle comprises an actuator mounted on a stem which is connected to a valve for controlling flow out of the bottle. When the nozzle is operated, the pressure is released via a hole in the actuator and the fluid is sprayed, typically in the form of an aerosol.

### SUMMARY

According to a first aspect disclosed herein, there is provided a spray nozzle device, the spray nozzle device comprising: a connector for connecting the device to a container containing a fluid; an inlet valve to which a pump or a source of pressurised gas is removably attachable to allow the interior of a said container to be pressurised; and a spray nozzle constructed and arranged so that, when the device is connected to a said container, the interior of which has been pressurised via the inlet valve, operation of the spray nozzle causes fluid to be sprayed from the container via the spray nozzle.

The spray nozzle device can be used to quickly and easily turn practically any container into a reusable spray “can”. The container may be for example a bottle, that is, a container having a relatively narrow neck. The fluid may be, for example, paint, ink, wood stain, pesticide, fungicide, etc.

In an example, the connector is located at the bottom of the device for fitting to a complementary connection on the top of a said container.

In an example, the connector is a screw-threaded connection for screw-fitting the device to a complementary screw-threaded connection on a said container.

In an example, the spray nozzle device comprises a main body to which the inlet valve and the nozzle are mounted, and the connector and the main body are separate parts which are assembled together.

In an example, the spray nozzle device comprises at least one alignment feature for aligning the connector relative to the main body when the connector and the main body are assembled together. The alignment feature may be, for example, one or more nibs, bosses, ridges, projections and blind recesses for aligning the different components.

In an example, the spray nozzle device comprises a housing, and the main body and connector are located within the housing when the device is assembled.

In an example, the spray nozzle device comprises at least one alignment feature for aligning the housing with the main body. The alignment feature may be, for example, one or more nibs, bosses, ridges, projections and blind recesses for aligning the different components.

In an example, the inlet valve is selected from: a Schrader valve, a Presta valve, a Dunlop valve and a poppet valve. This may allow a standard bike pump to be connected to the inlet valve for use as a “pressure source” for pressurising the container. Different sources of compressed gas or gasses (e.g. compressed air) may be used.

In an example, the inlet valve is located on a side of the device. This makes it easier for the user to attach a source of pressurised gas.

In an example, the inlet valve is located on the top of the device. This can simplify manufacture. It can also allow the device to be manufactured smaller, using less material.

In an example, the inlet valve is removable. This allows the inlet valve to be removed for cleaning. It also allows the inlet valve to be replaced with a different type of valve.

In an example, the spray nozzle device comprises a dip tube for extending into a said container when the device is attached to a said container.

In an example, the spray nozzle device has a polygonal shape. This can make it easier for the user to attach (e.g. screw) the device onto the container.

According to a second aspect disclosed herein, there is provided a kit of parts of a spray nozzle device, the kit comprising: a connector for connecting to a container containing a fluid; an inlet valve to which a pump or source of pressurized gas is removably attachable; a spray nozzle; and a main body to which the connector, inlet valve and spray nozzle are mountable to assemble the spray nozzle device; wherein, when the spray nozzle device is assembled and connected to a container using the connector: the interior of a said container can be pressurised using the inlet valve; and when the interior of the container has been pressurised, operation of the spray nozzle causes fluid to be sprayed from the container via the spray nozzle.

### BRIEF DESCRIPTION OF THE DRAWINGS

To assist understanding of the present disclosure and to show how embodiments may be put into effect, reference is made by way of example to the accompanying drawings in which:

FIGS. 1a-e show schematically a perspective view, a side view, a top view, a front view and a bottom view respectively of a first example, spray nozzle device;

FIG. 2 shows schematically a cross-section view of the device corresponding to the side view of FIG. 1b;

FIG. 3 shows schematically the device attached to a container in a state in which the container is to be pressurised;

FIG. 4 shows schematically the device attached to a container in a state in which the device is to be used for spraying a fluid;

FIG. 5 shows schematically an exploded perspective view of a second example spray nozzle device; and

FIG. 6 shows schematically a cross-section view of the second example device in an assembled state.

### DETAILED DESCRIPTION

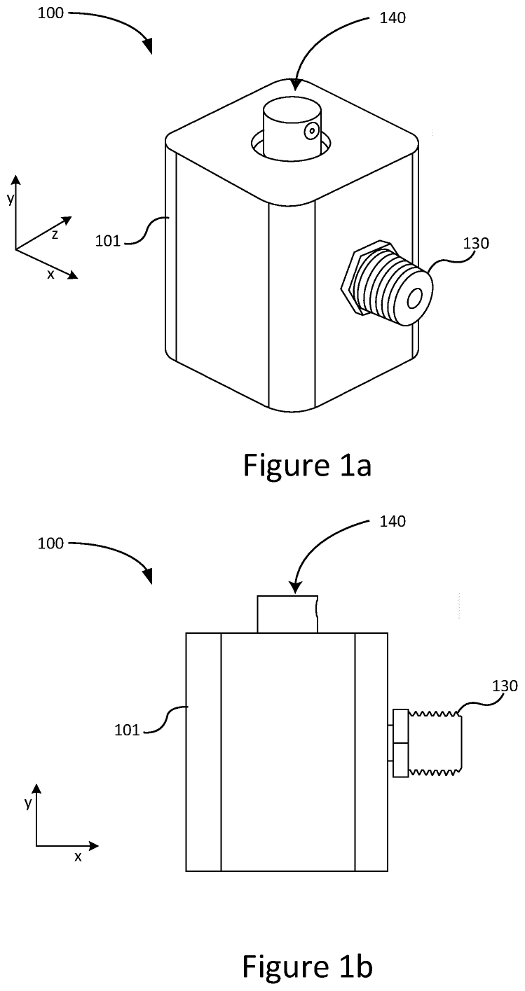

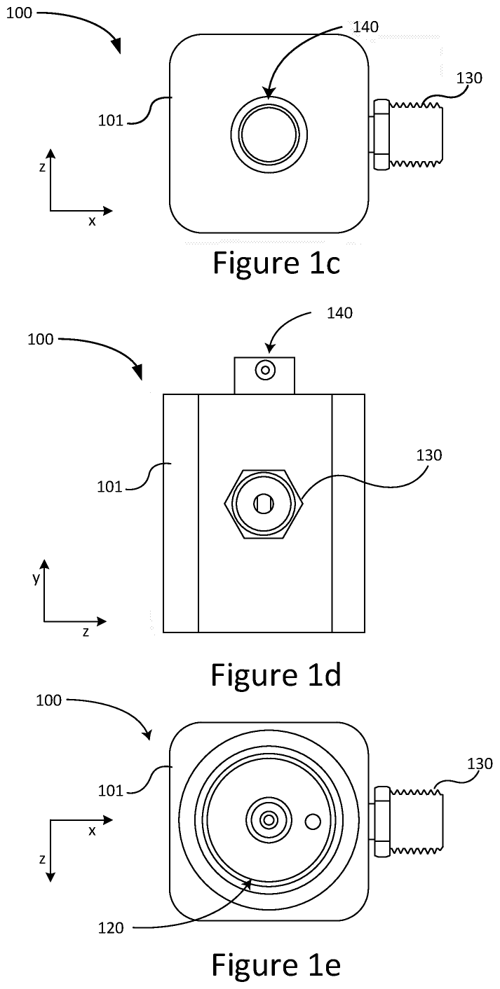

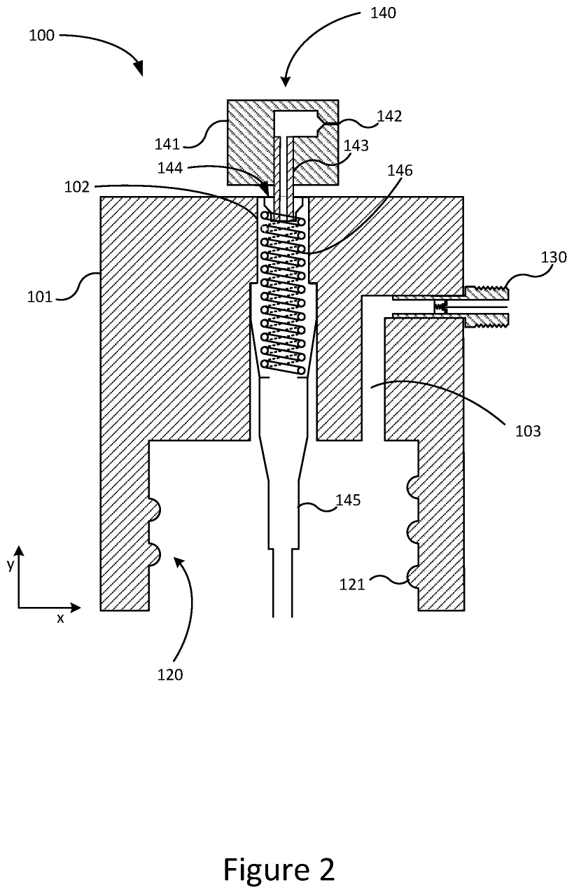

FIGS. 1a-e show schematically a perspective view, a side view, a top view, a front view and a bottom view respectively of a spray nozzle device 100 (also referred to herein as simply “device 100”) in accordance with examples described herein. Not all elements of the device 100 are visible in all views. FIG. 2 shows a cross-section view of the device 100 corresponding to the side view of FIG. 1b. The device 100 has a connector 120, an inlet valve 130 and a spray nozzle 140 (also referred to herein as simply “nozzle 140”).

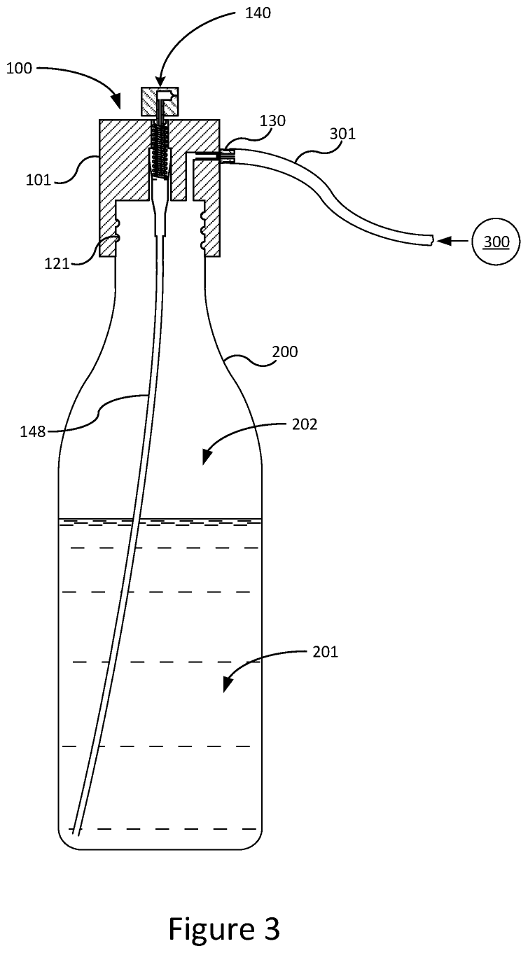

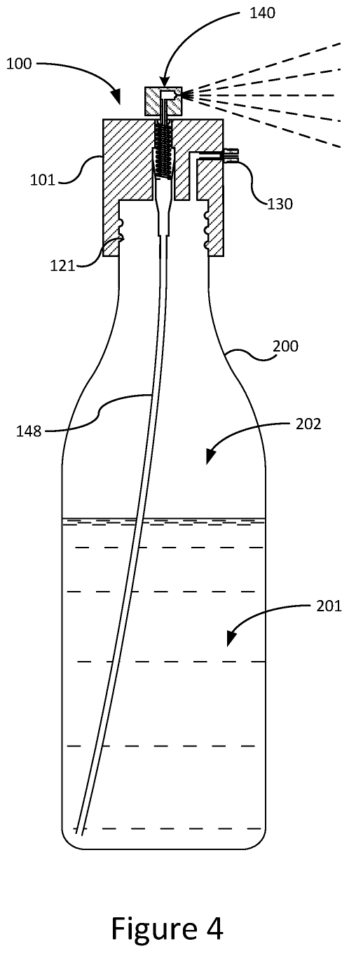

The connector 120 allows the device 100 to be connected or attached to a container 200 and disconnected or detached from the container 200. The container 200 may be for example a bottle, that is, a container having a neck that is relatively narrow compared to the main body of the container. FIGS. 3 and 4 (returned to later below) show examples in which the device 100 is removably attached to a bottle 200 which contains a liquid 201.

In this example, the inlet valve 130 and the nozzle 140 are mounted in a main body 101 of the device 100. Specifically, the nozzle 140 is mounted in a first channel 102 of the main body 101 and the inlet valve 130 is mounted in a second channel 103 of the main body 101. The first channel 102 and second channel 103 are provided within the main body 101 for coupling the nozzle 140 and inlet valve 130 to the interior of the connector 120, respectively. The nozzle 140 and inlet valve 130 may be mounted to any side of the device 100. In this example, the first channel 102 is a through-hole from the top of the main body 101 to the connector 102 and the second channel 103 is a through-hole from a side of the main body 101 to the connector 102.

Nozzles of the general type used herein are known per se and so the nozzle 140 will not be described in detail. The nozzle 140 comprises a button-like actuator 141 having an outlet hole 142 through which liquid is sprayed in use, typically in the form of an aerosol. The actuator 141 is mounted to a stem 143 which is connected to a valve 144 which controls fluid flow through the nozzle 140. The stem 143 extends into a housing 145 of the nozzle 140. The nozzle 140 also comprises a spring 146 for biasing the valve 144 to a closed position.

As mentioned, the nozzle 140 is mounted in the first channel 102 of the main body 101. For example, the nozzle 140 may be mounted into the first channel 102 using e.g. a screw-threaded connection or a push-fit connection. In this example, the nozzle 140 is mounted with the stem 143 protruding out the top of the first channel 102 (from the top of the device 100). The valve 144 and spring 146 are located within the first channel 102, and the housing 145 extends down into the connector 120. When the device 100 is connected to a container 200, the housing 145 of the nozzle 140 extends towards the interior of the container 200. A dip tube 148 may be connected to the housing 145 for further extending into the container 200 as shown in FIGS. 3 and 4.

Once the device 100 is attached to a container 200, the interior of the container 200 can be pressurised by connecting the inlet valve 130 to a source of pressure. As mentioned, the inlet valve 130 is mounted in the second channel 103 in the main body 101. For example, the inlet valve 130 may be mounted into the second channel 103 using a screw-threaded connection or a push-fit connection. Because the second channel 103 is a through-hole to the connector 120, air (or another gas or mixture of gases) input via the inlet valve 130 passes through the second channel 103 to the container 200 via the connector 120 when the device 100 is attached to a container 200. This allows the container 120 to be pressurised using via inlet valve 130.

Once the interior of the container 200 has been sufficiently pressurised, the nozzle 140 can be operated to cause the liquid 201 to be sprayed from the container 200 via the nozzle 140.

In short, the device 100 can be used to quickly and easily turn practically any container (including for example a plastics drinks bottle or the like) into a reusable spray “can”. This avoids the waste that often occurs because people would otherwise use and then throw away a number of different spray cans after a single use. Further, this encourages re-use of containers such as drinks bottles or the like, which, again, are often otherwise simply thrown away after a single use.

Because the connector 120, inlet valve 130, and nozzle 140 are all provided in a single device 100, the device 100 is very easy to operate by a user. In particular, the device 100 can be attached to and removed from different containers 200 very easily. This allows the user (e.g. an artist) to quickly swap between containers containing different paints, for example.

Moreover, the inlet valve 130 allows the interior of the container 200 to be pressurised using any gas, including in particular air. This avoids the need for and cost of providing a non-air propellant, such as butane, propane, NO₂, CO₂, etc. as often used in conventional spray cans.

In the example of FIG. 2, the connector 120 is located at the bottom of the device 100 for fitting to a complementary connection on the top of the container 200. (It will be understood that terms like “top” and “bottom”, etc., are used herein to describe locations when the parts are used in a typical or normal orientation.) It is not excluded, however, that the connector 120 may be located on a side of the device 100. For example, when located on a side of the device 100 the connector 120 can be used to connect the device 100 to a container 200 which has its complementary connection on a side.

Various different types of connector 120 are possible. In a first example, the connector 120 is provided by a recess which has an internal screw thread 121 for screw-fitting the device 100 to a complementary screw-threaded connection on the container 200. In these examples, the recess has a circular cross section. In a second example, the connector 120 is provided by a recess which has a push-connector which can be forced onto a container 200, which may or may not have a screw thread 121. In these examples, the recess may have a circular or non-circular cross section. The push-connector may be for example an internal ridge which projects into the recess. In either example, the connector 120 may have a standard size to fit, for example, plastic drinks bottles.

In the example of FIG. 2, the connector 120 is integrally provided by the main body 101 of the device 100. That is, the recess providing the connector 120 is a recess in the main body 101 of the device 100 itself. An advantage of this arrangement is the simplification of manufacture of the device 100. In other examples (discussed in more detail below), the connector 120 and the main body 101 may be provided as separate parts. That is, the connector 120 may be provided as a recess (as before) in a separate unit from the main body 101. In these examples, the main body 101 has a recess for receiving the connector 120. An advantage of this alternative arrangement is that the connector 120 may be replaceable or interchangeable, e.g. to fit containers having different connections (e.g. different sizes and/or different types of screw thread).

There are two main stages of operation once the device 100 is connected to a container 200: a) pressurisation of the interior of the container 200; and b) spraying of the contents of the container 200. Pressurisation of the interior of the container 200 is achieved via the inlet valve 130. Spraying of the contents of the container 200 is achieved via the nozzle 140.

The pressurisation process will now be described with reference to FIG. 3.

In use, the container 200 contains a liquid 201 to be sprayed out through the nozzle 140. For example, the user may pour the desired liquid to be sprayed into the container 200 before attaching the device 100 to the container 200 using the connector 120. The container 200 is part-filled with the liquid 201. The remainder of the interior of the container 200 contains air 202. The liquid 201 may be, for example, paint, ink, wood stain, pesticide, fungicide, etc.

The inlet valve 130 is removably attachable to an external pressure source 300 for pressurising the interior of the container 200. In particular, the inlet valve 130 is arranged such that air that is input via the inlet valve 130 passes to the connector 120 via the second channel 103. When the device 100 is attached to a container 200, this means that the air will pass from the inlet valve 130 into the container 200. The external pressure source 300 may be, for example, a bike pump or an air compressor. Gases other than air may be used.

In the example of FIG. 3, the inlet valve 130 is located on a side of the main body 101 of the device 100. An advantage of the inlet valve 130 being located on a side is that it can be easier for the user to attach and detach the external source of pressure 300. Another advantage is that the inlet valve 130 is located out of the way of the nozzle 140, in particular, out of the way of the spraying direction of the nozzle 140.

In other examples, the inlet valve 130 may be located on the top of the main body of the device 100. An advantage of the inlet valve 130 being located on the top is that the device 100 can be made thinner.

It is appreciated that the location of the inlet valve 130 relative to the connector 120 determines the construction of the second channel 103. In general, the second channel 103 is provided for allowing air to flow from the inlet valve 130 into the container 200. In the example shown in FIG. 3, the inlet valve 130 is located on the side (front) of the device 100 and the second channel 103 passes through the main body 101 to connect the inlet valve 130 to the connector 200.

Once the interior of the container 200 has been sufficiently pressurised, the pressure source 300 can be disconnected from the inlet valve 130 or can be left connected to the inlet valve 130 at the user's convenience and/or depending on the nature of the pressure source 300. Because the inlet valve 130 can be removably attached to a source of pressure as and when it is required, the device 100 does not require an integral source of pressure. This is advantageous because the device 100 is small and therefore the container 200 with device 100 attached is easier to manipulate by the user. Further, it also means that the container 200 also does not require an integral source of pressure, which allows the container 200 to be for example a simple drinks bottle or the like.

The inlet valve 130 may be any type of valve which can be selectively opened and sealed to air (or another gas) in order to allow the container 200 to be pressurised. Suitable types of valve include, for example, a Schrader valve, a Presta valve, a Dunlop valve, a poppet valve (also known as a mushroom valve). In some examples, the inlet valve 130 is removably attached to the main body 101 of the device 101, e.g. by a screw connection, allowing the inlet valve 130 to be removed and replaced. An advantage of this is that the inlet valve 130 can be removed for cleaning. Another advantage is that the inlet valve 130 can be replaced by a different type of inlet valve, e.g. suited to a different type of pressure source 300.

The spraying process will now be described with reference to FIG. 4.

In FIG. 4, the container 200 has been pressurised (using the inlet valve 130, as described above) and the pressure source 300 has been detached from the inlet valve 130. In this state, operation of the nozzle 140 causes the liquid 201 to be sprayed from the container 200 due to the pressure within the container 200.

As mentioned above, in this example, the nozzle 140 is located on the top of the device 100. An advantage of this arrangement is that it is easier for the user to operate as the actuator 141 is easily accessible on the top surface of the device 100. However, it is not excluded that the nozzle 140 may be located on a side of the device 100 in other examples.

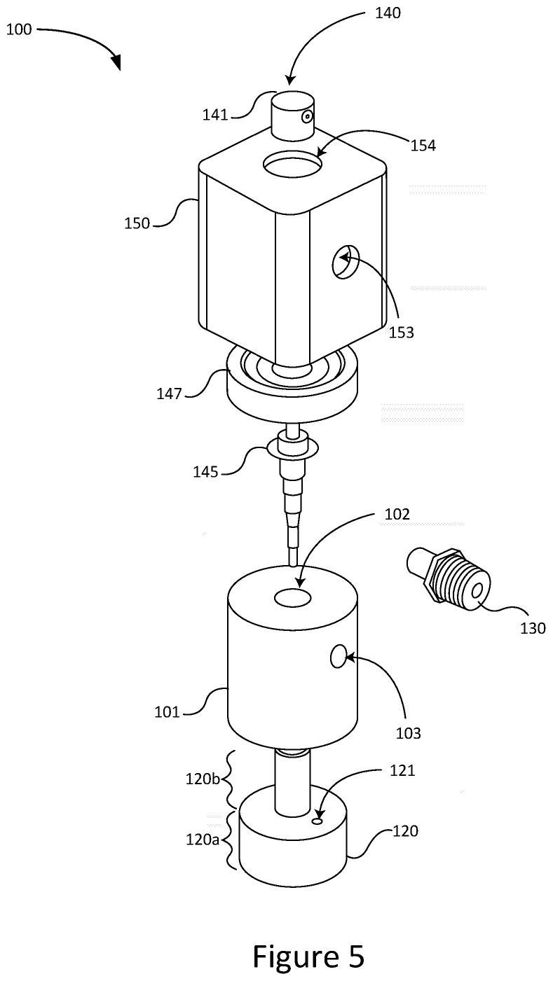

In some examples, the nozzle 140 is removably attached to the main body 101 of the device 101, e.g. by a screw or push connection, allowing the nozzle 140 to be removed and replaced. A specific example of a removable nozzle 140 is described below in relation to FIG. 5. An advantage of a removable nozzle 140 is that the nozzle 140 can be removed for cleaning.

The user operates the nozzle 140 by pressing down on the actuator 141. Force is transferred via the stem 143 to open the valve 144, thereby releasing pressure within the container 200 via the nozzle 140. This causes the contents of the container 200 to be forced up the dip tube 148, through the housing 145 of the nozzle 140, and out of the actuator 141 via the outlet 142. Because the dip tube 148 extends down into the liquid 201, this means that the liquid 201 is sprayed from the outlet 142.

Each operation of the nozzle 140 causes the pressure within the container 200 to decrease. Eventually, the pressure will no longer be sufficient to cause the liquid 201 to be sprayed from the nozzle 140. At this point, the user may reconnect the inlet valve 130 to the pressure source 300 (or a different pressure source) to re-pressurise the container 200 for further spraying.

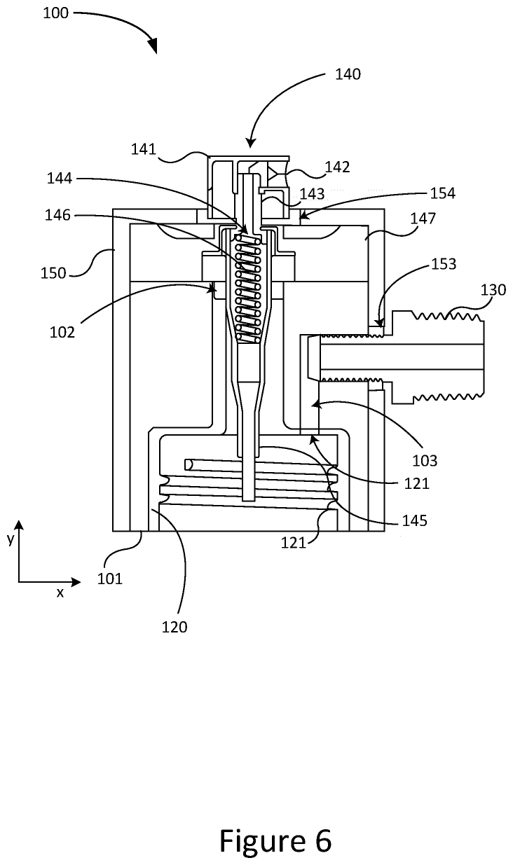

FIGS. 5 and 6 show schematically another example of a device 100 according to the present disclosure. FIG. 5 shows an exploded perspective view and FIG. 6 shows a cross section of the same example device 100 in its assembled state. Parts that are the same as or correspond to parts of the examples above have the same reference numerals and will not be described in detail again here.

The device 100 has a generally hollow housing 150 in addition to the main body 101, connector 120, inlet valve 130, and nozzle 140 described above. In this example, the connector 120 is provided separately from the main body 101.

The housing 150 fits over the main body 101 of the device 100 and holds the nozzle 140 in place, as described further below. The housing 150 may have a polygonal exterior cross-sectional shape. An advantage of this is that it is easier for the user to apply torque to the housing 150 in order to screw the device 100 onto and unscrew the device 100 from a container 200. The corners of the housing 150 may be rounded to provide a more ergonomic shape. In the example shown, the housing 150 has a square cross-sectional shape.

The connector 120 has a hollow, generally tubular shape for allowing fluid to flow through the connector 120 to the container 200 from the inlet valve 130 and from the container 200 to the nozzle 140. In this example, the connector 120 has a generally hollow cylindrical shape, having a generally funnel-like shape, with a first portion 120a having a first diameter and a second portion 120b having a second diameter which is smaller than the first diameter. The first portion 120a and second portion 120b are axially aligned and meet at a solid boundary surface, forming a “neck”, at which the diameter changes. Hence, the connector 120 has a generally T-shaped lateral cross section. Each end of the connector 120 is open and, as mentioned, the connector 120 itself is hollow. Hence, fluid may flow through the connector 120 from one end to the other. The first portion 120a in this example provides the recess having a screw thread or push connection as described above.

The connector 120 is constructed to fit into a corresponding recess in the main body 101. In this example, the second portion 120b of the connector 120 extends into the first channel 102 of the main body 101. In particular, the second portion 120b may be sized relative to the first channel 102 such that an interference fit (i.e. a “tight” fit) is provided between the second portion 120b and the first channel 102. Similarly, the first portion 120a may be sized to provide an interference fit with the recess in the main body 101. An advantage of this is that a hermetic seal is provided between the connector 120 and the main body 101. This ensures that no gas escapes from the device 100 when attached to the container 200, especially when the container 200 has been pressurised. Alternatively or additionally, a sealing gasket or the like (not shown) may be used to ensure a good seal is formed.

A hole 121 in the connector 120 is provided to allow gas to flow into the connector 120 (and therefore the container 200) from the second channel 103. In this example, the hole 121 is located through the upper face the wider first portion 120a of the connector 120. The hole 121 aligns with the second channel 103. An alignment feature (not shown) may be provided to prevent the connector 120 from rotating within the main body 101 (e.g. to maintain alignment between the hole 121 and the second channel 103). Examples of alignment features include nibs, bosses, ridges, projections or the like on one of the connector 120 and the main body 101 and a corresponding depression or blind recess or the like on the other of the connector 120 and the main body 101.

In this example, the nozzle 140 has a disc 147 as shown in FIG. 5 between the housing 145 of the nozzle 140 and the actuator 141. The disc 147 extends radially outward from the housing 145 of the nozzle 140. The nozzle 140 may be, for example, a typical nozzle as provided for a conventional aerosol can. In such cases, the disc 147 corresponds to the mounting cap of a conventional aerosol can (which is to be crimped to the rest of the aerosol can during manufacture of a conventional aerosol can). The disc 147 is fixed to the nozzle 140. The main body 101 and the disc 147 have the same cross sectional shape and size in this example.

When the device 100 is assembled, as shown in FIG. 6, the housing 145 of the nozzle 140 extends through the first channel 102 of the main body 101 and into or at least towards the connector 120. The disc 147 aligns centrally with the top of the main body 101.

The housing 145 may push-fit into the connector 120 (the second portion 120b of the connector 120 in this example) to provide a hermetic seal between the connector 120 and the housing 145 of the nozzle 140. This ensures that pressure within the container 200 is released via the nozzle 140. Alternatively or additionally, the disc 147 may be sealed to the top of the main body 101 (e.g. with glue).

The housing 150 has a first hole 154 for receiving the actuator 141 of the nozzle 140 and a second hole 153 for receiving the inlet valve 130. It is appreciated that the locations of the first hole 154 and second hole 153 in the housing 150 depend on the location of the first channel 102 and second channel 103 of the main body 101, respectively (i.e. the location of the first hole 154 corresponds to the location of the first channel 102 and the location of the second hole 153 corresponds to the location of the second channel 103). When the device 100 is assembled, the actuator 141 extends through and out of the first hole 154 in the housing 150 where it can be operated by the user. An alignment feature (not shown) may be provided to prevent the main body 101 from rotating within the housing 150 (e.g. to allow the application of torque). Examples of alignment features include nibs, bosses, ridges and projections or the like and corresponding depressions or blind recesses or the like.

The connector 120, inlet valve 130, spray nozzle 140 and main body 101 may be provided and sold separately as a kit of parts. The user can assemble the device 100 from the kit, as described above.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A spray nozzle device, the spray nozzle device comprising:
a connector for connecting the device to a container containing a fluid;
an inlet valve to which a pump or a source of pressurised gas is removably attachable to allow the interior of a said container to be pressurised; and
a spray nozzle constructed and arranged so that, when the device is connected to a said container, the interior of which has been pressurised via the inlet valve, operation of the spray nozzle causes fluid to be sprayed from the container via the spray nozzle.

2. A spray nozzle device according to claim 1, wherein the connector is located at the bottom of the device for fitting to a complementary connection on the top of a said container.

3. A spray nozzle device according to claim 1, wherein the connector is a screw-threaded connection for screw-fitting the device to a complementary screw-threaded connection on a said container.

4. A spray nozzle device according to claim 1, the spray nozzle device comprising a main body to which the inlet valve and the nozzle are mounted, and wherein the connector and the main body are separate parts which are assembled together.

5. A spray nozzle device according to claim 4, comprising at least one alignment feature for aligning the connector relative to the main body when the connector and the main body are assembled together.

6. A spray nozzle device according to claim 1, comprising a housing, wherein the main body and connector are located within the housing when the device is assembled.

7. A spray nozzle device according to claim 6, comprising at least one alignment feature for aligning the housing with the main body.

8. A spray nozzle device according to claim 1, wherein the inlet valve is selected from: a Schrader valve, a Presta valve, a Dunlop valve and a poppet valve.

9. A spray nozzle device according to claim 1, wherein the inlet valve is located on a side of the device.

10. A spray nozzle device according to claim 1, wherein the inlet valve is located on the top of the device.

11. A spray nozzle device according to claim 1, wherein the inlet valve is removable.

12. A spray nozzle device according to claim 1, wherein the spray nozzle comprises a dip tube for extending into a said container when the device is attached to a said container.

13. A spray nozzle device according to claim 1, wherein the device has a polygonal shape.

14. A kit of parts of a spray nozzle device, the kit comprising:
a connector for connecting to a container containing a fluid;
an inlet valve to which a pump or source of pressurized gas is removably attachable;
a spray nozzle; and
a main body to which the connector, inlet valve and spray nozzle are mountable to assemble the spray nozzle device;
wherein, when the spray nozzle device is assembled and connected to a container using the connector:
the interior of a said container can be pressurised using the inlet valve; and
when the interior of the container has been pressurised, operation of the spray nozzle causes fluid to be sprayed from the container via the spray nozzle.

15. A spray nozzle device, the spray nozzle device comprising:
a connector for connecting the device to a container containing a fluid; and
a main body comprising:
an inlet valve to which a pump or a source of pressurised gas is removably attachable to allow the interior of a said container to be pressurised; and
a spray nozzle constructed and arranged so that, when the device is connected to a said container, the interior of which has been pressurised via the inlet valve, operation of the spray nozzle causes fluid to be sprayed from the container via the spray nozzle;
wherein the connector and the main body are separate parts which are assembled together; and
wherein the device has a polygonal shape.
